(19) United States
(12) Patent Application Publication
(10) Pub. No.: US 2013/0346385 A1
(43) Pub. Date: Dec. 26, 2013

(54) SYSTEM AND METHOD FOR A PURPOSEFUL SHARING ENVIRONMENT

(71) Applicant: Revew Data Corp., Austin, TX (US)

(72) Inventors: Andrew P. Kraftsow, Sedona, AZ (US); David T. Croley, Austin, TX (US)

(21) Appl. No.: 13/924,299

(22) Filed: Jun. 21, 2013

Related U.S. Application Data
(60) Provisional application No. 61/662,907, filed on Jun. 21, 2012.

(51) Int. Cl. G06F 17/30

(52) U.S. Cl. CPC G06F 17/30867
USPC 707/708

(57) ABSTRACT

The present invention is directed to systems and method for a purposeful sharing environment.

### CROSS REFERENCE TO RELATED APPLICATIONS

This application is a claims priority to and the benefit of U.S. Provisional Application No. 61/662,907 filed on Jun. 21, 2012, the contents of which are incorporated herein by reference.

### BACKGROUND OF THE INVENTION

1. Field of the Invention

The present invention relates to systems and methods involving collecting, organizing, sharing, and recommending content.

2. Introduction

People who share an interest in a subject bring with them a unique set of perspectives that color how relevant they will find any particular piece of content. One difficulty in determining or recommending content relevant to a person is understanding the context in which a person is collecting or storing such content. Other systems can identify or recommend content based on word searching, usage statistics, or popularity of a piece of content. However, the context surrounding simple word matches or popularity rankings produce results that are many times too voluminous to be meaningful or not relevant to the current context in which the search has been conducted. For example, a professional runner who might have hurt herself may search an article database for treatment options. Without proper context, the particular search may return articles directed towards a range of amateurs to professionals, children to adults, or women and men. However, other professional runners who have hurt themselves before may have collected articles specific to their situation.

Based on the premise that you are what you consume (e.g., read, view, listen to) there is a need for creating an environment that enables people to purposefully share their content. There is a need to share that content in at least two ways (1) share content that is similar to content a person is consuming and (2) identify users and their content who will find similar content of interest based on a particular perspective to a particular topic. In other words, a system and method is needed to connect people to similar content and to connect users and their content based on those are “like me” relative to a particular topic and content. There is also a need for providers of content, products, or services to better tune their content or advertising for products and services to those that are likely to consume the content, products, or services.

### SUMMARY OF THE INVENTION

While the way in which the present invention addresses the disadvantages of the prior art will be discussed in greater detail below, in general, the present invention relates to systems and methods for facilitating purposeful sharing of information. The systems and method provide an environment for a purposeful sharing system.

A purposeful sharing system includes a storage system, a sharing system, and a recommendation system. The storage system includes any hardware and/or software suitably configured to collect, store, and manage data and information for use in the system. The storage system includes a categorization engine. The sharing system includes any hardware and/or software suitably configured to enable viewing of content between users of the purposeful sharing system. The recommendation system includes any hardware and/or software suitably configured to recommend content to a user based on a user's particular perspective to a particular topic.

A method for purposefully sharing content includes the steps of storing content in a database, organizing content into discrete partitions, sharing the partitions, indexing the stored content, and recommending content based on similar content of interest and/or recommending content that is shared between users based on a particular perspective to a particular topic.

A method for recommending content within a purposeful sharing system includes creating a hierarchy of partitions or categories that cover meaningful aspects of a broader subject is created. Small amounts of content that represent the partitions are assigned to each partition. Users indicate content within the system as shareable. The strength of a particular piece of content's match to a cluster is computed. The cluster list and content store of a user is matched against other users' cluster lists and content stores of the shared partition. A similarity score may be computed and used to recommend content.

Additional features and advantages of the invention will be set forth in the description which follows, and in part will be obvious from the description, or may be learned by practice of the invention. The features and advantages of the invention may be realized and obtained by means of the instruments and combinations particularly pointed out in the description. These and other features of the present invention will become more fully apparent from the following description, or may be learned by the practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. It should be understood that these drawings depict only typical embodiments of the invention and therefore, should not be considered to be limiting of its scope. The invention will be described and explained with additional specificity and detail through the use of the accompanying drawings in which:

FIG. 1 illustrates an exemplary purposeful sharing system.

FIG. 2 illustrates a method for recommending content within a purposeful sharing system.

FIG. 3 illustrates an exemplary method for purposefully sharing content.

### DETAILED DESCRIPTION OF THE INVENTION

Various exemplary embodiments of the invention are described in detail below. While specific implementations involving electronic devices (e.g., computers) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

Although not required, this invention may be described in the general context of computer-executable instructions, such as program modules. Generally, program modules include routines, programs, objects, scripts, components, data structures, etc., that perform particular tasks or implement particular abstract data types. Moreover, those skilled in the art will appreciate that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in and/or with personal computers (PCs), hand-held devices, multiprocessor systems, microprocessor-based or programmable consumer electronics, network PCs, minicomputers, mainframe computers, cloud computing, and any device connectable to the Internet and the like.

The present invention facilitates purposeful sharing of information. In particular, the invention provides a system and method for collecting content into a location accessible through a variety of devices, organizing the content, recommending organization of the content, sharing the content, and recommending additional content. Content includes a variety of file formats, information, and/or data. A non-limiting list of content and file formats include articles, text, word processing, spreadsheet, or presentation documents, Portable Document Files, visual media such as pictures, video, and the like. File formats include .doc (Microsoft Word), .xls (Microsoft Excel), .ppt (Microsoft Powerpoint), .pdf, EPub, .rtf (Rich Text Form), .bmp, .jpg, .jpeg, .gif, .png, .tiff, .msg, .eml, .mp3, .mp4, .m4v and the like. Audio files, emails, web pages, Internet bookmarks, and text messages are included in the type of content that may be utilized. Thus, as will become apparent from the following descriptions, the systems and methods of the invention facilitate collecting and organizing, sharing, and recommending information and media.

For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices. Additionally, the components and/or devices may employ voice-activated technology to perform various functions of the invention.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, Microsoft Mobile, UNIX, Apple OS X, MacOS, Apple iOS, Android, Linux, and the like. Software elements may also include utilizing the services of a cloud-based platform or software as a service (SaaS) to deliver functionality to the various system components.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, DVDs, optical storage devices, magnetic storage devices, solid state storage devices and/or the like.

The computer program instructions may be loaded onto a general purpose computer, special purpose computer, or other programmable data processing apparatus to produce a machine, such that the instructions execute on the computer or other programmable data processing apparatus and create means for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that instructions which execute on the computer or other programmable apparatus provide steps for implementing the functions specified in the flowchart block or blocks.

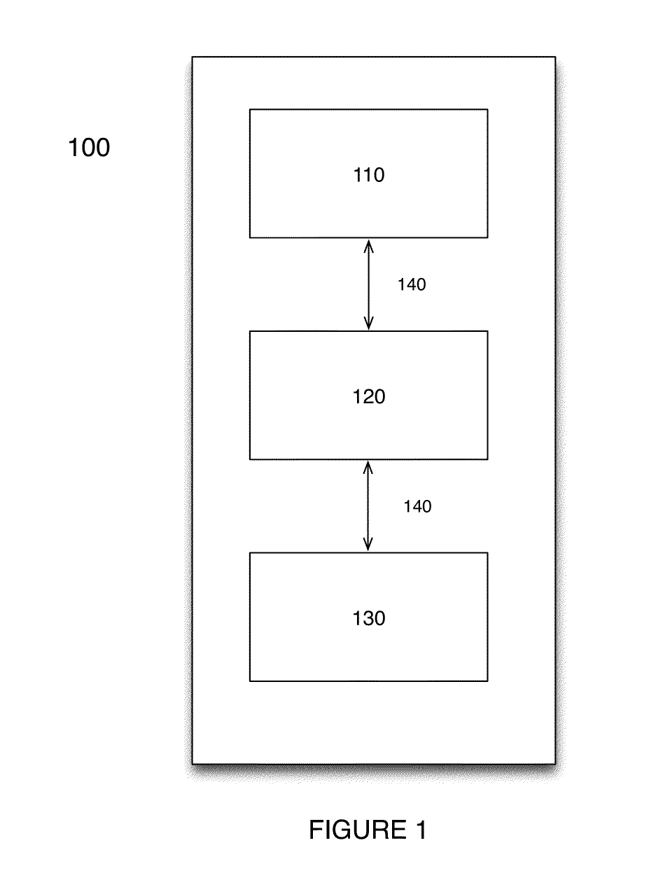

FIG. 1 illustrates, in block format, an exemplary purposeful sharing system 100 of the invention. In one exemplary embodiment, a purposeful sharing system comprises a storage system 110, a sharing system 130, and a recommendation system 130. Depending on the physical configuration, these systems may use a variety of methods to communicate with each other. For example, in some exemplary embodiments, the systems may communicate over one or more networks 140 using protocols suited to the particular system and communication. As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. In some embodiments, the storage, sharing, and recommendation system may share hardware and software components. In other exemplary embodiments, each system is contained within a single physical unit and appropriately coupled through various integrated circuit components.

The storage system includes any hardware and/or software suitably configured to collect, store, and manage data and information for use in the system. In general, the storage system is implemented as a combination of hardware and application software configured to upload, download, or delete content and stores such content at a location accessible via a network. Uploaded content is converted to a format that enables non-destructive alteration or modification to the content within the system. Once content is uploaded, converted, and stored, a user may view the content. A user includes, but is not limited to, another system or device or a person(s) accessing content in the system through a device. Content may also be deleted via the storage system. In some exemplary embodiments, the content may be modified, altered, or marked at the user's discretion. In an exemplary embodiment, a user may highlight portions of the content. In another exemplary embodiment, a user may associate a note with the content. In yet another embodiment, the storage system also enables a user to associate a tag with the content. Tagging content enables a user to add additional information to the stored content. Such modifications, alterations, or markings may be stored with the content or could be stored separately in another storage system depending on the configuration of the storage system. In an exemplary embodiment, all forms described or modification, alteration, or marking are incorporated into the purposeful sharing system. Stored content may also be downloaded to another location. In an exemplary embodiment, a particular user's content is organized into a collection sometimes referred to as a library of content, or simply, a library.

The storage system may also comprise a user interface implemented as a combination of hardware and application software configured to enable access to and viewing of the content and to the features of the purposeful sharing system. Additionally, the may be accessible via a touch screen, keyboard, mouse, stylus, display, audio receiver/speaker, or a combination thereof and the like. In an exemplary embodiment, the purposeful sharing system is accessible via a web browser. In another embodiment, the purposeful sharing system is accessible via a tablet computer or a portable device such as a smart phone. However, any device that can communicate via networks and display a user interface into the purposeful sharing system is suitable. In general, the user interface enables user to login and access the system. Once in the system, a user is presented with one or more views of the stored content. In some exemplary embodiments, the view has been partitioned into discrete arrangements of information, for example, a list or display of categories. However, any partition scheme enabling access to the stored content is suitable. The user interface also enables access to the other features of the system such as searching or filtering, sharing, account settings, uploading or downloading content. The user interface enables the creation of new partitions and management of those partitions. Features also in the user interface are described below including auto-categorization, a location to place content waiting to be analyzed and stored, and an option to create notes. The user interface includes the ability to manipulate content and other features of the system utilizing drag and drop functionality.

The storage system includes a searching engine. In general, the search engine implemented as a combination of hardware and application software configured to retrieve content from the storage system upon query. Content may be found utilizing a number of criteria, for example, such as type, tags, date or any other criteria suitable for segregating and finding content within the system. In one exemplary embodiment, content may be found based on its similarity to other content. In another exemplary embodiment, content may be found based on content stored or read by users of a similar profile.

The storage system includes a categorization engine. In general, the categorization engine is implemented as a combination of hardware and application software configured to categorize content within the storage system. Content may be viewed and/or stored according to its categorization. In various exemplary embodiments, a user of the purposeful sharing system through the user interface may assign categories to all, some, or none of the content. In other exemplary embodiments, the categorization engine will perform and the categorization and storage of content automatically, that is, without need for additional input from a user other than uploading the content into the purposeful sharing system. In such embodiments, the storage system displays the content in various categories according to the category settings.

In other exemplary embodiments, the categorization engine determines a suitable category for uploaded content based on existing categories for previously categorized content. The categorization process employed by the categorization engine may depend, at least in part, on the quantity of content within a particular category. New categorization may also depend on the existing categorization of the content. In one exemplary embodiment, the categorization engine determines a category for newly uploaded content based on already categorized content that meets an arbitrary quantity of content threshold. In other exemplary embodiments, more than one categorization method may be utilized according to such arbitrary threshold. In an exemplary embodiment, the arbitrary threshold is set at four pieces of content. In other exemplary embodiment, a vector is used to determine categorization. When a vector is strong enough when compared against possible categories, then a piece of content may be categorized within such a category. However, any suitable threshold may be determined based on the particular application.

In various exemplary embodiments that meet the arbitrary threshold, an index is created from all or some of the content currently in a particular collection of documents. The index is searched and content similar to the test content is retrieved. Many techniques are well known to index and search content and will not be described. However, in an exemplary embodiment, a feature known as the MoreLikeThis class in Lucene, a known search engine tool, is used to index and search the content. Analysis and retrieval by the MoreLikeThis class or similar feature is beneficial in searching because it avoids search engine optimization (SEO) efforts which have come to plague many search engine results (e.g., overuse of keywords in content or meta content). For example, by comparing a term or terms across a collection of documents, the resultant scores will indicate a better match for a topic or category for the content. In an exemplary embodiment, fifteen of the most important words within a document are identified and weighted to use for a search. However, the number of words to be identified and weighted may change according to the specific application. These search results are sorted by score and only the highest percent are retained for analysis. A non-limiting percentage of content to retain, for example, is 66% of the search results. However, any suitable percentage may be used depending on the particular application. The current categories of the content in the search results are analyzed and the category with the highest result becomes the suggested category for the new content. In some exemplary embodiments, more than one category may be suggested. Also, in various embodiments, a category's score may need to meet a minimum threshold before being suggested.

In other exemplary embodiments that do not meet an arbitrary threshold, each existing category is preprocessed. One or more category names are used to search a pre-existing collection of content. One such non-limiting example of collection of content may be the collection known as Wikipedia®. However, any suitable collection of content may be used depending on the particular application. The top scoring search results are considered. The number of search results to consider is configurable based on the particular application. In an exemplary embodiment, the number of search results to consider is configurable from one to three. The content from the search results are processed to produce a weighted term vector to represent the category being processed. Many techniques are well known to compute term vectors and will not be described. However, in an exemplary embodiment, the feature known as MoreLikeThis described above, is used to compute the term vectors. The term vectors are pre-computed and stored for use when categorizing new content. When new content is presented for categorization, its term vector is compared to the stored vector and a score is computed. Then, the scored results are merged with the search results described above when determining possible categories. In various exemplary embodiments, categorization may be used to create sub-categories within each category. Sub-categorization occurs in the same manner described above.

The sharing system includes any hardware and/or software suitably configured to enable viewing of content between users of the purposeful sharing system. In accordance with the present invention, the sharing system enables users of the system to selectively share content and the organization of that content. Features available on the sharing system may include any suitable activity used to partition the content in the storage system, select one or more of those partitions to share with other users of the system, and send an indication that the shared partitions are available for use by the other users. In various embodiments, a partition is a category assigned to a collection of content. In an exemplary embodiment, a partition is a category assigned to a collection of documents. In other exemplary embodiments, a partition is the full collection of documents within a user's storage system. Exemplary features are described below, however, it is understood that additional features may be implemented to control the sharing system depending on the particular application. In various exemplary embodiments, the sharing system assigns a variety of permissions to the content partitions. These partitions may be assigned at the content and/or collection level. For example, a permission may be assigned to a document. A separate permission may be assigned to the partition or partitions (e.g., category) in which the document is assigned. Permissions may include read only access, or the ability to modify, alter, or mark content, markings or notes associated with the content, or a collection of content or combinations thereof. For example, one may designate a piece of content as read only and include the piece of content into a partition. If the content piece is shared, it can only be read without alteration. The partition, however, may be designated with a permission level allowing other users to add pieces of content to the partition. Such combination of permission levels enables for a robust sharing experience between users. It is intended that any combination of permission levels be within the scope and spirit of the invention.

Another feature of the sharing system is the ability to create, modify, or delete a sharable partition. In accordance with exemplary embodiments of the invention, content pieces are associated into a partition. Multiple partitions are presented to a user for sharing. The user selects the partition(s) to share and communicates to other users the availability of the shareable partition. In some exemplary embodiments, users of the purposeful sharing system are presented so that the user may simple select other users through a user interface to send a notice of the sharable partition. In other exemplary embodiments, another delivery method such as an email address can be entered into the system. Various other exemplary embodiments include delivery methods such as text or SMS messaging, notification messages, emails, social media messaging (e.g., Facebook® notifications, Twitter®) and similar delivery methods that are able to notify a user of the presence of a sharable partition in the purposeful sharing system. Other users access the sharable partition through their access to the storage system according to the sharable partition's permission set when shared.

The recommendation system includes any hardware and/or software suitably configured to recommend content to a user based on a user's particular perspective to a particular topic. In general, people who share an interest in a subject possess a unique set of perspectives that affect how relevant they will view a particular piece of content. In accordance with the invention, a recommendation system identifies (1) similar content based on a particular piece of content and/or (2) content based on users who are similar to a current user, or “like me.” Thus, the recommendation system finds similar content of interest based on a particular perspective to a particular topic. Underlying the purposeful sharing system is an inference that similar or “like” users who have collected similar content on related topics are “alike.” In various exemplary embodiments of the invention, the similar interest analysis is based on the content within a particular user's collection of content and shared content between users. For example, shared content is organized into clusters. The clusters are used as a reference set to measure interest-similarity among individual users of the shared content. In one embodiment this is accomplished by mapping individual users' collections of content against the clusters of the shared content. Users whose content matches the shared content clusters in similar patterns and frequencies are deemed to be of similar interest, or “alike.” An inference is then made that those with alike content are people who are alike. Content directed towards a certain interest group then can be recommended to those alike people. In various exemplary embodiments, the date a piece of content was added to a user's storage is included in the recommendation analysis. In other words, the more recent a piece of content was viewed correlates to a higher relevance to the recommendation.

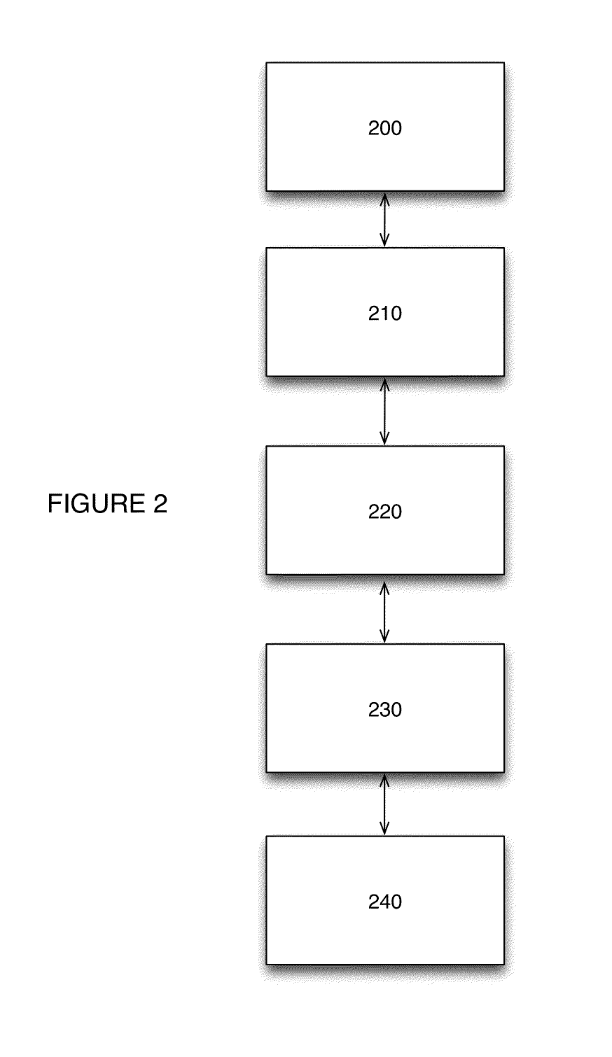

FIG. 2 presents an exemplary method of the recommendation system. A hierarchy of partitions or categories that cover meaningful aspects of a broader subject is created, step 200. Next, small amounts of content that represent the categories are assigned to each category, step 210. In some embodiments, the content are documents. The content need not be part of a user's storage system, but could be added to the categories by an administrator or other process (e.g., artificial intelligence). The amount of content needed may depend on a variety of factors such as the topic and/or subject matter, the desired sensitivity of the overall recommendation system, complexity of the subject matter, the number of users of the purposeful sharing system, the number of partitions/categories created to describe a particular subject, and the like. This content is known as the “seed” of a shared partition.

Next, users of the purposeful sharing system indicate content within their storage system as “shareable,” which enables such content to be available to the shared partition for analysis, step 220. The shared partition now contains content from users and “seeded” content (a process referred to as “peer-sourcing”). User sharing is tracked so that the system understands which users are contributing which content. Duplicate content is removed via a “near-dupe” technique without losing the source of the shared content. The de-duplicated content is then categorized into the hierarchy of partitions created at the beginning of the method. In some embodiments, a user may assist the categorization process by creating additional partitions, or choosing suitable partitions for content that did not get categorized during the categorization process. In an exemplary embodiment, the categorization process is the categorization process described above.

Next, the strength of a particular piece of content's match to a cluster is computed, step 230. Stated another way, this score is usually defined as a piece of content's “distance” from a cluster's center. Sometimes this measure of strength is termed a fitness score. The score is obtained by executing a clustering algorithm across the content and data within a shared partition. Once such algorithm used is a model-based algorithm like Dirichlet clustering. The Dirichlet algorithm is well known and will not be described in detail. However, any algorithm that assists in characterizing the strength of a content's match is suitable for the system. In one embodiment using a clustering algorithm, the number of clusters equals the number of partitions initially created.

Each piece of content in a user's storage system is compared to each cluster in the shared partition. Cluster matches and scores for each content piece are noted. An example of a comparison is represented below in Table Y:

TABLE Y

| | |
|---|---|
| User 1 | Cluster 1 (doc1, 0.80; doc2, 0.30), Cluster 2 (doc3, 0.31), |
| | Cluster 5 (doc4, 0.12) . . . |
| User 2 | Cluster2 (doc1, 0.90, doc2, 0.80) . . . |
| User 3 | Cluster2 (doc1, 0.29), Cluster 5 (doc2, 0.20) . . . |

Next, the cluster list and content store of a user is matched against other users' cluster lists and content stores of the shared partition, step 240. Users whose profiles closely match each other are considered to be alike, i.e., they have similar interest perspectives on the content of the shared partition. For example, for Table Y, user 1 and user 3 are inferred to be alike because they both have content in clusters 2 and 5 with similar weights. In some embodiments, a similarity score may be computed between users and used for comparison. For example, a similarity score between users i and j (Sᵢⱼ) is computed by summing the reciprocal of the difference between the weights of the matching clusters. A constant factor cis added to the denominator to limit the maximum score.

$${S}_{ij} = \sum \frac{1}{\vert {w}_{i} - {w}_{j} \vert + c}$$

An optional step of the method includes adding negative information into the computation of the scores. For example, clusters that are not in common between users may be considered. One way to incorporate such negative information is to subtract from the similarity score the reciprocal of non-matching clusters.

The invention in its various embodiments enables content to be syndicated. In various exemplary embodiments of the recommendation system, content providers may recommend content based on the results of the recommendation engine. For example, a service or product provider may want to submit an advertisement, possibly in the form of an advertorial, to the system. The recommendation system analyzes the advertorial in accordance with the methods and systems above and selects users of the purposeful sharing system that may be interested in the content. The recommendation system may then insert the advertorial into the selected user's storage.

In another exemplary embodiment, a content provider such as a blogger may submit their content to the purposeful sharing system. The content of the blog is then stored, categorized, and recommended based on the recommendation methods and systems above. In other exemplary embodiments, the blog is created as a shared partition and shared.

The purposeful sharing system includes any hardware and/or software suitably configured to provide reports of activity within the system. In its various exemplary embodiments, activity such as the type of content, categories assigned to content, where users have filed content, the time and/or date content was consumed, which users viewed certain content, profile attributes of users and the like can be reported on. Reporting systems for database systems are well known and will not be described.

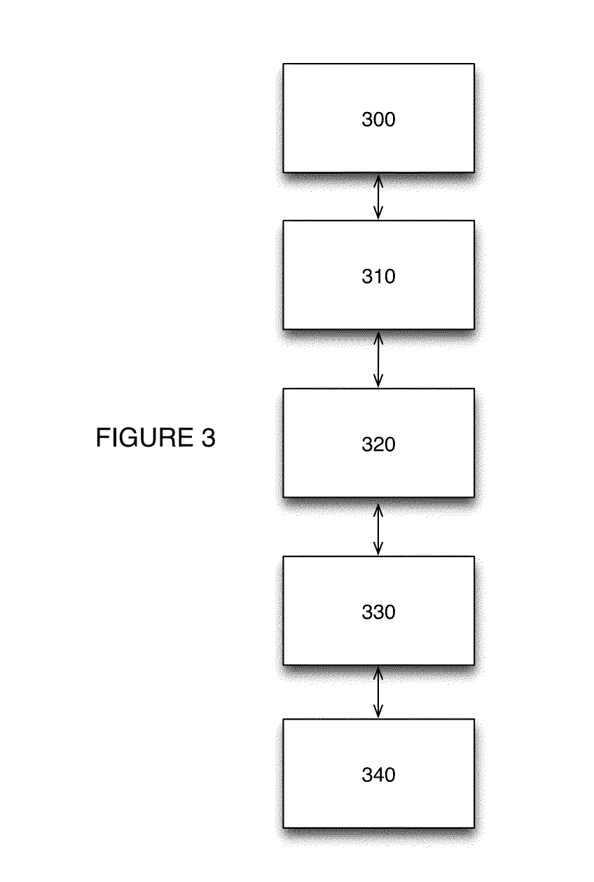

FIG. 3 illustrates, in block format, a method for purposefully sharing content. The method comprises the steps of storing content in a database 300, organizing content into discrete partitions 310, sharing the partitions 320, indexing the stored content 330, and recommending content based similar content of interest on a particular perspective to a particular topic 340.

In this method, content is stored into a database. In one embodiment, a user uploads content into the database via a user interface. In other embodiments, a user uploads content via network connections. The type content that may be uploaded is unlimited. However, typical content to upload are articles, text, word processing, spreadsheet, or presentation documents, Portable Document Files, visual media such as pictures, video, and the like. The file formats include articles, text, word processing, spreadsheet, or presentation documents, Portable Document Files, visual media such as pictures, video, and the like. File formats include .doc (Microsoft Word), .xls (Microsoft Excel), .ppt (Microsoft Powerpoint), .pdf, EPub, .rtf (Rich Text Form), .bmp, .jpg, .jpeg, .gif, .png, .tiff, .msg, .eml, .mp3, .mp4, .m4v and the like. Audio files, emails, web pages, Internet bookmarks, and text messages are included in the type of content that may be utilized. In another embodiment, the uploaded content may be modified, altered, marked, or deleted. Examples of modifications, alterations or markings are highlights or associating notes with the content. In some embodiments, the content may also be tagged.

In this exemplary method, content is organized into discrete partitions. In some embodiments, content is organized into partitions by a processor based on the content's similarity to other content within other user's partitions. In other embodiment, a user places the content into self-described partitions. In an exemplary embodiment, the partitions are categories.

In this exemplary method, partitions of content may be shared between users of the system. A user partitions the content into one or more partitions. The user selects one or more partitions to share and other users that the user wishes to share the partitions with. After selection, an indication of available sharable partitions is sent to the users.

In this exemplary method, stored content is indexed. A variety of indexing methods may be used suitable to a particular application. In some embodiments, the indexing is based on similarity of content on related topics that are alike.

In this exemplary method, content may be recommended to users of the system. In its embodiments, users of the purposeful sharing system are identified that may find a piece a content interesting to view or listen to based on similarity characteristics. FIG. 2 is an exemplary method of recommending content to users.

Appendix A illustrates, through various screen shots and documents, one embodiment of the present invention. This embodiment is commercially known as Libreeze®.

Although the above description may contain specific details, they should not be construed as limiting the claims in any way. Other configurations of the described embodiments of the invention are part of the scope and spirit of this invention.

What is claimed:

1. An information sharing system comprising:
a content storage system configured to store user content in a database, the content storage system comprising:
a user interface;
a search engine configured to retrieve content from the database based upon a query; and
a categorization engine configured to automatically categorize the user content into one or more partitions based on a weighted term vector;
a sharing system in communication with the content storage system, the sharing system configured to partition the user content into one or more partitions so that the one or more partitions may be shared with another user of the purposeful sharing system; and
a recommendation system in communication with the sharing system and the content storage system, the recommendation system configured to:
organize the user content into one or more cluster lists;
compute a measure of strength of a piece of content using a clustering algorithm across the one or more cluster lists;
compute a similarity score between one or more cluster lists by summing the reciprocal of the difference between the weights of matching clusters;
recommend the piece of content based on the similarity score.

2. The system of claim 1, wherein the content storage system is further configured to convert the user content to a format that enables non-destructive alteration to the user content.

3. The system of claim 1, wherein the content storage system is accessible via a web browser.

4. The system of claim 1, wherein the user interface is configured to present the user content as one or more categories.

5. The system of claim 1, wherein the user interface allows a user to apply a tag to at least a portion of the user content.

6. The system of claim 1, wherein the user content is categorized using the MoreLikeThis class in Lucene.

7. The system of claim 1, wherein categorization is based on a minimum threshold before being categorized.

8. The system of claim 1, wherein the categorization engine categorize the user content into a sub-category.

9. The system of claim 1, wherein the sharing system is permission based.

10. The system of claim 1, wherein a partition is only shared with a subset of the users of the purposeful sharing system.

11. The system of claim 1, wherein the similarity score incorporates the date the piece of content was added to the content storage system.

12. The system of claim 1, wherein the similarity score incorporates the date the user last viewed the piece of content.

13. The system of claim 1, wherein the similarity score incorporates negative information into the computation.

14. The system of claim 13, wherein the negative information is a reciprocal of non-matching clusters and is subtracted from the similarity score.

15. The system of claim 1, wherein the recommendation system is further configured to insert the piece of content into a particular user's content storage.

16. The system of claim 1, wherein the recommended content is a blog.

17. A method for sharing information among a plurality of users comprising the steps of:
storing a user content in a database;
organizing the user content into discrete partitions;
sharing the partitions;
indexing the user content based on a weighted term vector;
organizing the user content into one or more cluster lists;
computing a measure of strength of a piece of content using a clustering algorithm across the one or more cluster lists;
computing a similarity score between one or more cluster lists by summing the reciprocal of the difference between the weights of matching clusters;
recommending the piece of content based on the similarity score.

18. The method of claim 17, further comprising the steps of: uploading the user content into the content storage system and converting the content into a format that enables non-destructive alteration to the user content.

19. The method of claim 17, presenting through a user interface the user content as one or more categories.

20. The method of claim 17, further comprising the step of tagging to at least a portion of the user content.

21. The method of claim 17, further comprising the step of categorizing the user content using the MoreLikeThis class in Lucene.

22. The method of claim 17, wherein categorization is based on a minimum threshold before being categorized.

23. The method of claim 17, further comprising the step of categorizing the user content into one or more sub-categories.

24. The method of claim 17, wherein sharing the content is permission based.

25. The method of claim 17, wherein further comprising the step of sharing a partition with a subset of the users of the purposeful sharing system.

26. The method of claim 17, further comprising the step of incorporating the date the piece of content was added to the content storage system into the similarity score.

27. The method of claim 17, further comprising the step of incorporating the date the user last viewed the piece of content into the similarity score.

28. The method of claim 17, further comprising the step of incorporating negative information into the similarity score.

29. The method of claim 28, wherein the negative information is a reciprocal of non-matching clusters and is subtracted from the similarity score.

30. The method of claim 17, further comprising the step of automatically inserting the recommended piece of content into a particular user's content storage.
